(19) United States
(12) Patent Application Publication
(10) Pub. No.: US 2015/0130912 A1
(43) Pub. Date: May 14, 2015

(54) PROJECTOR FOR USE WITH TELEVISION DISPLAY

(71) Applicants: Sony Network Entertainment International LLC, Los Angeles, CA (US); Sony Corporation, Tokyo (JP)

(72) Inventors: Clay FISHER, San Diego, CA (US); True XIONG, San Diego, CA (US); Charles MCCOY, Coronado, CA (US)

(73) Assignees: Sony Network Entertainment International LLC, Los Angeles, CA (US); Sony Corporation, Tokyo (JP)

(21) Appl. No.: 14/079,729

(22) Filed: Nov. 14, 2013

(51) Int. Cl. H04N 21/41; H04N 5/57; H04N 13/04; H04N 21/422; H04N 21/435; H04N 21/81; H04N 5/445; H04N 9/31

(52) U.S. Cl. CPC H04N 21/4122; H04N 5/445; H04N 5/57; H04N 9/3179; H04N 21/42204; H04N 21/435; H04N 21/8133; H04N 21/816; H04N 13/0497
USPC 348/54; 348/552

(57) ABSTRACT

A display system used with a television display. An image projector is supplied with image information that differs from but is related to the television content displayed by the television display. Image information is decoded from the content information supplied to the display system and supplied to the image projector. As a result, the image projector projects an image on a surface separate and apart from the display screen of the television display.

### FIELD OF THE INVENTION

This invention relates to a display system and, more particularly, to a display system having an image projector for use with a television display to enhance viewing the video content displayed by the television display.

### BACKGROUND OF THE INVENTION

Typical television displays provide a viewer with an image of video content that is displayed on a screen of fixed size. While television display screens may be very large, the peripheral area surrounding the display screen typically is a blank wall. This peripheral area usually provides a static display that, in the room in which the television display normally is located, is not visually exploited. As a result, the viewer's experience is less realistic, especially when compared to the visual experience in a movie theater where the audience views a large screen that occupies a larger portion of the field of view. The peripheral area around the movie screen is proportionally smaller (as compared to the peripheral area surrounding a television display screen) and is dark to minimize distractions inasmuch as there is nothing in that peripheral area that corresponds to the content displayed on the screen.

If the peripheral area surrounding the television display screen is advantageously utilized to provide visual imaging to complement or otherwise correspond to the television content displayed on the television display screen, the viewer's visual experience will be improved.

Therefore, it is an object of the present invention to provide a display for use with a television display that improves and enhances the viewer's visual experience while viewing the television content.

It is another object of this invention to project images on a surface proximate the television display, thereby improving the viewer's periphery enjoyment.

A further object of the invention is to control an image projector to project an image separate and apart from a television display screen in accordance with image information related to the television content being displayed.

Various other objects, advantages and features of the invention will become readily apparent from the ensuing detailed description; and the novel features will be particularly pointed out in the appended claims.

### SUMMARY OF THE INVENTION

In accordance with some embodiments of this invention, a display system comprises an image projector for use with a television display, the image projector being supplied with image information that differs from but is related to the displayed television content. Image information is discriminated from content information supplied to the display system; and the image information is supplied to the image projector which projects an image on a surface separate and apart from the television display screen.

In one embodiment, the image information is supplied to the display system as metadata.

In another embodiment, the image information and television content are supplied in separate channels, such as in the separate channels used in a 3-D television system.

In a further embodiment, predetermined parameters in the video content are discriminated and used to control different aspects of the image information supplied to the image projector.

### BRIEF DESCRIPTION OF THE DRAWINGS

The following detailed description, given by way of example and not intended to limit the present invention solely to those embodiments described herein, will best be understood in conjunction with the accompanying drawings in which:

FIG. 1 is a schematic representation of the display system in accordance with the present invention;

FIG. 2 is a schematic representation of another embodiment of the display system;

FIG. 3 is a block diagram of an embodiment of the present invention in the environment of an interactive network;

FIG. 4 is a block diagram showing additional details of the embodiment shown in FIG. 3;

FIG. 5 is a block diagram of yet another embodiment of the present invention;

FIG. 6 is a block diagram of a further embodiment of the present invention;

FIG. 7 is a block diagram of a still further embodiment of the present invention;

FIG. 8 is a block diagram of an embodiment of the present invention employing color compensation; and

FIG. 9 is a block diagram of a useful application of an embodiment of the present invention.

### DETAILED DESCRIPTION OF CERTAIN PREFERRED EMBODIMENTS

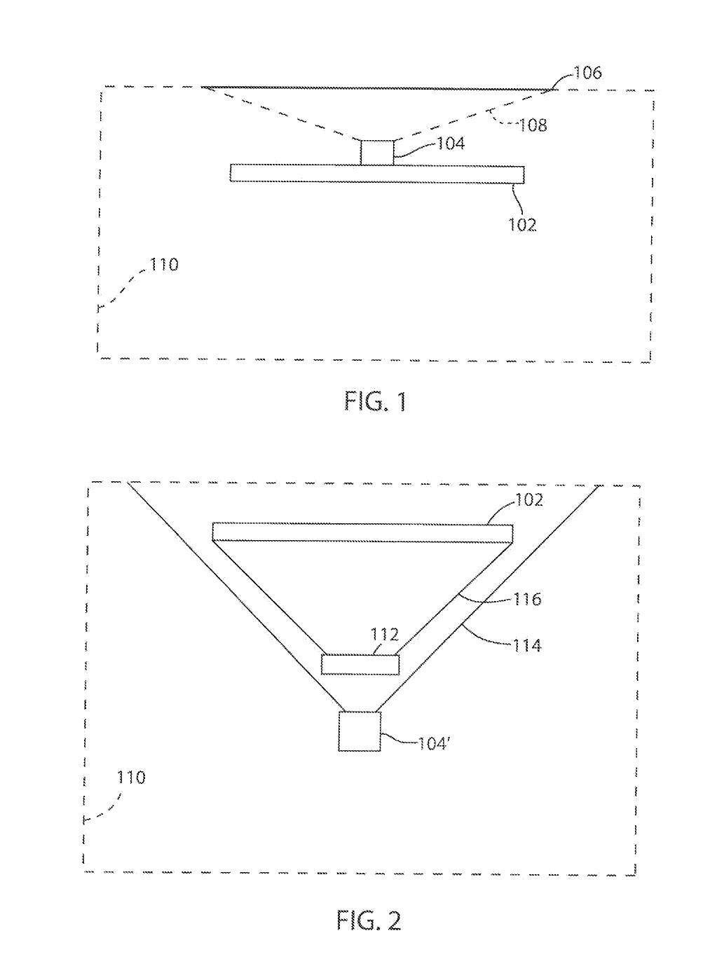

Referring now to the drawings, wherein like reference numerals are used throughout, and particularly to FIG. 1, there is illustrated a schematic representation of one embodiment of the present invention comprised of an image projector 104 used with a television (TV) display 102. Image projector 104 may be of the type sold by Sony Corporation; and in the illustrated embodiment, the image projector is mounted on or positioned proximate the back of TV display 102. The display system formed of the TV display and the image projector are provided in a room 110; and image projector 104 projects an image 108 onto a surface 106. Typically, surface 106 is a wall in room 110.

The illustrated display system is supplied with television content, such as typical video programs, stored content, recorded content (such as on optical or magnetic discs), from which the television content is supplied to TV display 102. A viewer positioned in front of the TV display screen thus may view the received television content supplied from, for example, terrestrial transmission, satellite transmission, cable TV transmission, Internet transmission or another active network supply.

The surface upon which the image is projected may be adjacent or near the TV display and need not necessarily surround the TV display screen.

The illustrated display system also is supplied with image information that differs from but is related to the television content displayed by the TV display 102. Examples of the image information are described below. This image information is applied to image projector 104 which, in turn, projects an image on wall 106. As will be described below, the image information may be in the form of metadata included with the received television content. Alternatively, the TV display may be a 3-D television display device that, when viewing 3-D programming, receives television content over separate channels, such as the left-eye and right-eye channels, which are processed by the 3-D television display device to display three-dimensional video images. If TV display 102 is a 3-D television display device, one of its channels (e.g. the left-eye channel) may be used to receive two-dimensional television content and the other channel (e.g. the right-eye channel) may be used to receive the image information. It will be appreciated that TV display 102 may be a 2-D television display device with a decoder operable to receive a 3-D formatted signal containing one channel on which 2-D content is transmitted and the other channel on which the image information is transmitted. As yet a further alternative, image projector 104 may include circuitry and/or software modules for discriminating predetermined parameters in the received television content to generate the image information. Various embodiments are described below.

Before describing the preferred embodiments of image projector 104, and particularly the apparatus used to provide the images projected by the image projector, examples of the usefulness of the illustrated display system are now described. In one example, the television content supplied to and displayed on TV display 102 may be a sporting event; and the image information supplied to image projector 104 may be a scoreboard or box score of that sporting event. As a result, image projector 104 may display on wall 106, as a peripheral display adjacent or surrounding the content displayed on the TV display screen, the box score of that sporting event.

As another example, the image projected on wall 106 by image projector 104 may be closed caption text related to the television content displayed on TV display 102. Such closed caption text may be a language translation of the dialogue in that television content, or may be supertitles or subtitles of a performance, for example, an opera.

A further example of the projected image may be selectable Internet items, such as products or icons, received via an interactive network, such as the Internet, that may be selected by the viewer similar to the selection of displayed items on a computer display screen in an interactive system. Examples of such selectable image items and apparatus operable by the viewer to select such items are described below.

A still further example of the projected image may be a wide-angle view of a scene that surrounds the view being displayed on TV display 102.

Yet another example of the projected image may be light whose color and intensity are controlled by the image information supplied to the image projector. For example, if the displayed television content represents a storm, the projected image may be flashes of light representing lightning. If the displayed television content represents an emergency scene, the projected image may be flashing colored lights representing the lights of emergency vehicles. As a further example, the projected image may be background color which matches or is compatible with the scene being displayed on the TV display. Or the projected image may be light of an intensity to match the intensity of ambient light in room 110.

In the embodiment shown in FIG. 1, image projector 104 may be an integral part of and assembled with TV display 102. Alternatively, the image projector may be a separate module, purchased separately and mounted on or adjacent TV display 102. FIG. 1 illustrates the mounting of image projector 104 on or to the rear of the TV display so as not to be visible by the viewer and not to interfere with the view of the displayed television content.

FIG. 2 as an alternate arrangement in which image projector 104′ is located in front of TV display 102. In this configuration, the projected image would be superimposed on the TV display screen, thereby interfering with the viewer's enjoyment of the television programming. This is avoided in the embodiment shown in FIG. 2 in which a light mask 112 is interposed between image projector 104′ and the display screen of TV display 102. As schematically shown, the projected image 114 from image projector 104′ is blocked by mask 112, thereby blocking a portion 116 of the projected image so as not to interfere with the displayed television content. Nevertheless, image projector 104′ may be controlled in the same way that image projector 104 (FIG. 1) is controlled. In one embodiment, the display screen of TV display 102 may be flush, or almost flush, with surface 106. For example, surface 106 may be a separate screen, or it may be the bezel (albeit a large bezel) of the TV display.

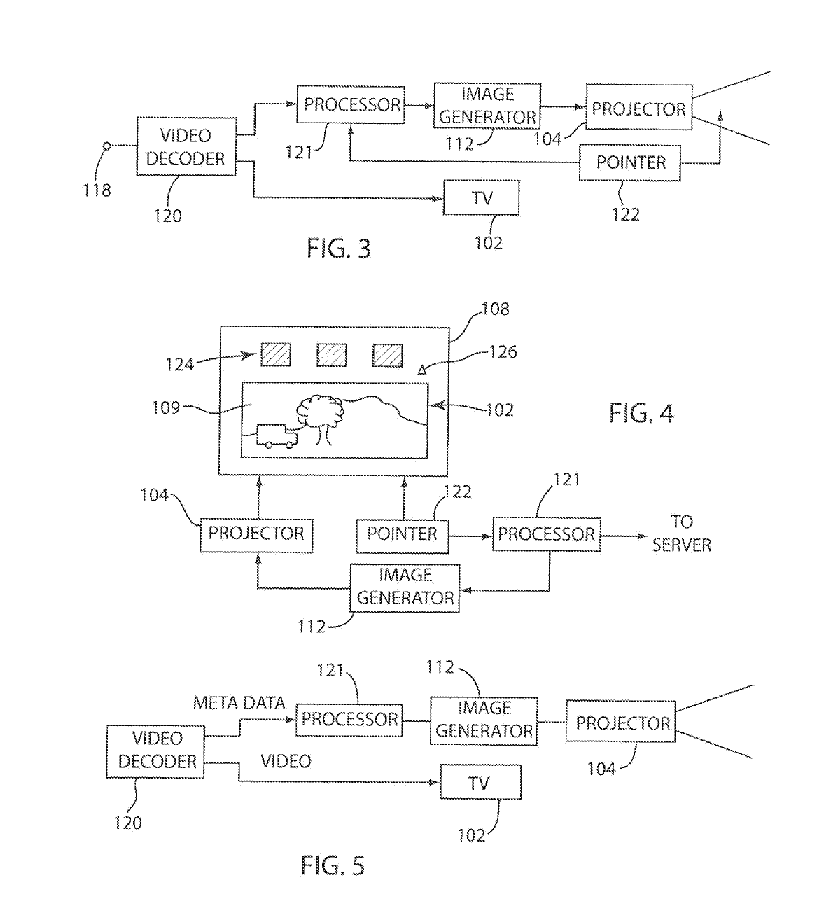

Turning now to FIG. 3, there is illustrated an embodiment of the present invention in the environment of an interactive network. This embodiment includes a video decoder 120, a processor 121, an image generator 112, image projector 104 and a pointer device 122. Decoder 120 is coupled to an input 118 to receive content information and image information supplied from, for example, the Internet. The manner in which the content information and image information are supplied is described in different embodiments below. Suffice it to say, decoder 120 separates the content and image information, supplying the content information to TV display 102 and the image information to processor 121 which, in turn, drives image generator 112 to supply image information to image projector 104. In this embodiment, the content information may be Internet information and the image information may be selectable images, such as text links, button graphics, icons or other Internet images typically used in interactive computer systems, including a web page.

A pointer device 122, such as a mouse, joystick, touch-sensitive screen, track pad, motion sensing controller, or other known pointer devices, including sensors adapted to sense gestures made by a user, is coupled to image projector 104. As schematically illustrated, image 108 projected by the projector onto the surface (not shown) includes the aforementioned Internet images. Pointer 122 communicates with processor 121 to drive image generator 112 to control image projector 104 to project a superimposed cursor onto the image 108. In this respect, pointer 122 interacts with processor 121 and image generator 112 to adjust the position at which the cursor is superimposed on the projected images in much the same way as a conventional mouse interacts with a laptop or desktop computer, resulting in the display of a cursor superimposed onto Internet images. Alternatively, the operation of pointer 122 may cause different ones of the Internet images to be high-lighted. Pointer 122 includes a user-operable switch that enables the viewer to select a displayed Internet image when the cursor is superimposed over that image or when that image is high-lighted. Since this is conventional, further description need not be provided.

In operation, image information supplied to image projector 104 by video decoder 120 causes the image projector to project Internet images determined by the image information. The viewer operates pointer 122 to superimpose the cursor over different selectable images that are projected. For example, the Internet images may be images of different products, different icons, different links, different buttons or different selectable items of the type normally displayed on a computer screen. When the user moves the cursor to a position superimposed over a desired item, the user may operate the switch on the pointer to select that item. Corresponding information is supplied to, for example, the source of the image information that supplied the image information to input 118 of the illustrated display system. As a result, the viewer may engage in online shopping, gaming or other online interactive activities.

A more detailed illustration of the operation achieved by the embodiment shown in FIG. 3 is illustrated in FIG. 4. Here, pointer 122 is schematically shown as being coupled to a detector 128 which is used to detect the selection of an Internet image by the viewer's operation of the pointer. FIG. 4 illustrates a TV image 109 displayed on TV display 102 and projected image 108 projected by image projector 104. As schematically shown, image 108 surrounds the periphery of the TV image 109.

Projected image 108 includes displayed items 124, which may be buttons, text links, icons, purchasable products or other selectable items. The projected image also includes cursor 126 which may be moved over the projected image 108 by operation of pointer 122. Operation of the pointer is processed by processor 121 which drives image generator 112 to supply to projector 104 an image of the cursor superimposed over the items 124 of projected image 108. When cursor 126 is superimposed over a desired one of displayed items 124, the viewer may operate the switch on pointer 122; whereupon processor 121 is supplied with information identifying the selected item 124. Processor 121 is a digital processor, a CPU, or the like, which sends to a server information identifying the selected item. The processor also communicates with image generator 112 to control the image projected by projector 104. It is appreciated, pointer 122, cursor 126, and processor 121 operate in a manner similar to the operation of a mouse in a conventional interactive computer system.

FIG. 5 is a block diagram of an embodiment of the present invention wherein the image information is in the form of metadata that accompanies video signals. Here, such video signals are supplied to input 118 from terrestrial transmissions, satellite transmissions, Internet transmissions, or the like. This embodiment is similar to FIG. 3 and includes video decoder 120, processor 121 and image generator 112. The video decoder is adapted to parse the metadata and the video signals and thereby separate the metadata from the video signals. The video decoder is coupled to TV display 102 to supply video signals for display on the TV display.

The metadata separated by decoder 120 is provided to processor 121 which is adapted to process the received metadata and drive image generator 112 to generate the image information of the type discussed above. Processor 121 is coupled to image generator 112 which supplies image information to control the image projector 104.

In operation, video decoder 120 detects and decodes the metadata supplied with the video signals to input 118. Such video signals are processed by the video decoder and supplied to TV display 102 which displays the television content represented by those video signals. The detected metadata is supplied to processor 121 which produces image information from the metadata. This image information is supplied to image generator 112 which controls image projector 104 to project a corresponding image on wall 106. The image data may represent a scoreboard, closed caption text, Internet items, intensity and/or color of light or other information mentioned above. If the metadata represents color or light intensity, processor 121 is adapted to process such color or light intensity; and image generator 112 controls image projector 104 to project an image whose color or brightness corresponds to the detected color light intensity. Alternatively, the metadata may represent image information that enhances the scene corresponding to the video signals displayed on TV display 102.

Examples of the metadata parsed by video decoder 120 include, among other types of information, closed captioning, program title, time remaining in the current program, content rating and the like. It will be understood that other types of information may be detected by the video decoder, such as blocks of data related to the video content. Detected text may be designated to be displayed directly, such as a description of the content displayed on TV display 102. Such text may be encoded with markup code such as XML, JSON, or HTML. Additionally, the metadata or markup code may contain URLs, or IDs that can be passed into API calls. The information from the text can be used to lookup data from a server. By using a URL or IDs to indicate the location of data on a network, a small amount of metadata can specify a large quantity of related data. While references to things on the network are common in markup codes such as HTML, the separated block of data could simply be a URL. The data, such as in HTML which commonly includes JavaScript, may also contain logic and other instructions to be executed by the processor 121 when evaluating the data. The data may also contain media, such as still images, audio, and/or video. In the case of video media, the resolution, frame rate, bit rate, codex used to encode the video data, and other properties of the video data may differ from the main video content to which the metadata is related.

In one configuration of the embodiment shown in FIG. 5, the video decoder, processor and image generator may be housed within a common housing, or module, sold as a separate, stand alone device. Input 118 may be adapted to receivevideo information, i.e. video signals and metadata, that otherwise would be received by a television display device. The output of the video decoder may be coupled to the conventional A/V input of TV display 102; and the output of image generator 112 may be coupled to image projector 104. Thus, this embodiment may be used to retrofit a conventional TV display.

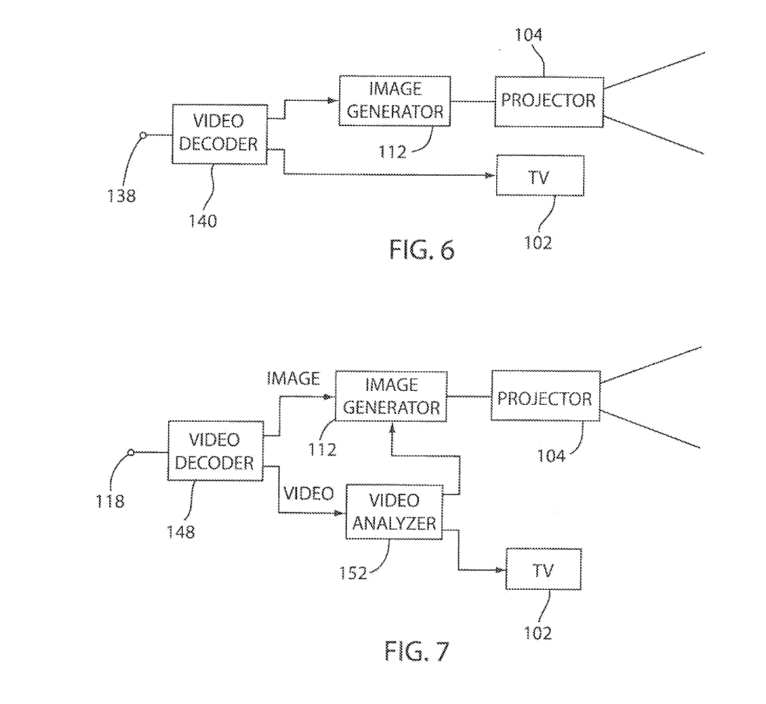

FIG. 6 illustrates yet another embodiment of the present invention in which the television receiving device is adapted to receive 3-D television signals. It is conventional to transmit 3-D television content over separate channels allocated to right-eye and left-eye video information. In the embodiment shown in FIG. 6, a video decoder 140 is coupled to input 138 to receive the 3-D television signals. Here, however, instead of transmitting right-eye and left-eye video information to input 138, 2-D television content and image information are supplied to the input. Video decoder 140 separates the received television content and image information.

Decoder 140 is coupled to supply TV display 102 with video signals. Decoder 140 also is coupled to image generator 112 to supply the separated image information for controlling image projector 104 with such image information. Thus, TV display 102 displays the received television content and image projector 104 projects an image on wall 106 related to but different from the television content, thereby enhancing the viewer's viewing experience.

FIG. 7 illustrates a further embodiment of the present invention and comprises a video decoder 148, a video analyzer 152 and image generator 112. Decoder 148 is coupled to input 118 and receives the television content and image information supplied thereto. The decoder is adapted to separate the received television content and image information by detecting, for example, packets containing header information unique to the television content or the image information. Alternatively, decoder 148 may be similar to decoder 120 shown in FIG. 3. As yet another alternative, decoder 148 may include a metadata detector. As shown, decoder 148 includes a video output coupled to TV display 102. Decoder 148 also includes an image information output coupled to image generator 112 (such as the image generator shown in FIG. 6); and the image generator is coupled to image projector 104.

The video output of decoder 148 also is coupled to a video analyzer 152 which is adapted to extract predetermined parameters included in the video signal, or television content, separated by the decoder. For example, the video analyzer is adapted to analyze frames of the video signal and to identify and extract the predetermined parameters included in the analyzed frames. Examples of such predetermined parameters include brightness (or light intensity) of the video signal, overall color, panning direction of the subject in the video signal, zooming direction of the video image, text information such as score information associated with a sporting event, background scene information, or even audio information such as sound intensity included in the television content. The extracted parameters are supplied to image generator 112 to control particular characteristics of the image information supplied by the image generator to image projector 104. For example, the color of the image projected by projector 104 may be controlled. Or the movement of displayed items (discussed in connection with FIG. 4) may be controlled. Or the inward or outward motion of the image projected by projector 104 may be controlled.

Examples of the operation of the embodiment shown in FIG. 7 now will be described. As one example, let it be assumed that the brightness of the received video signal is relatively high. This brightness parameter is extracted by video analyzer 152 and supplied to image generator 112 to control particular aspects of the image information, thereby providing a corresponding increase in brightness in the image projected by image projector 104. As another example, let it be assumed that the received television content includes subtitle information. This subtitle information is extracted by video analyzer 152 and supplied to image generator 112 to supply corresponding subtitle image data to image projector 104, thereby projecting subtitle images corresponding to the closed caption information.

As another example, let it be assumed that the television content is a sporting event. Score information related to the sporting event is extracted by video analyzer 152 and supplied to generator 112 which, in turn, supplies graphic data resembling a scoreboard to image projector 104. As a result, a scoreboard image is projected.

As a further example, let it be assumed that the television content includes a scene of a severe storm which includes thunder and lightning. Audio information representing the thunder, such as audio signals of low frequency and high intensity, are extracted by video analyzer 152 and supplied to image generator 112 which supplies image information representing bright flashes of light to the image projector 104.

Thus, in the embodiment shown in FIG. 7, image projector 104 projects images in accordance with the predetermined parameters included in the television content and extracted by video analyzer 152.

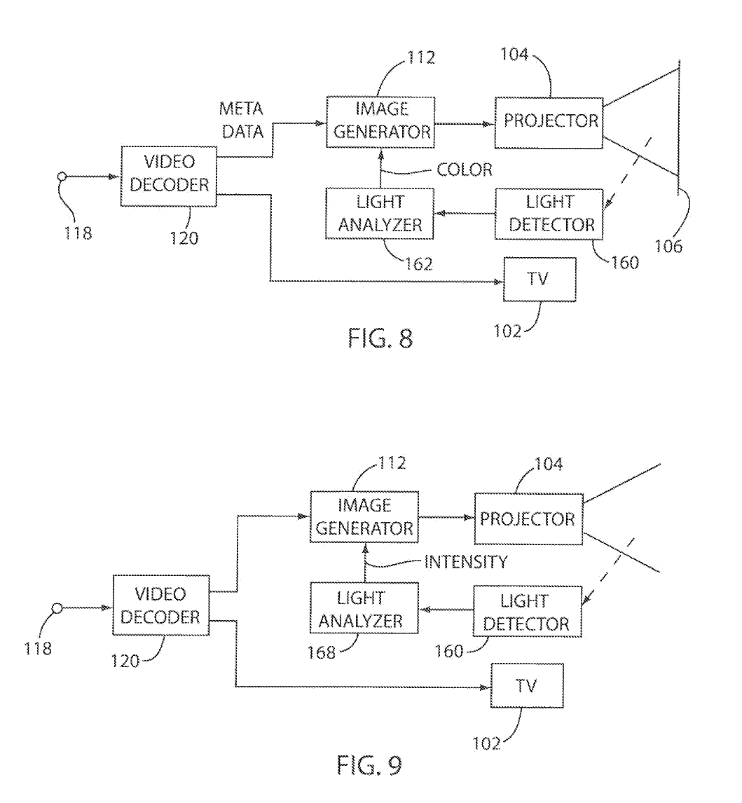

FIG. 8 illustrates a configuration for enhancing the image projected by the image projector and comprises image projector 104, image generator 112, a light sensor 160 and a light analyzer 162. As shown, image projector 104, which may be similar to the image projector of the embodiments described above, receives image information from image generator 112 to project a corresponding image 108 on surface 106. Light impinging on surface 106 is reflected therefrom and picked up by sensor 160, which may be a camera or other video pickup device. Depending upon the color of the surface 106, the color temperature of reflected light may differ from a predetermined color temperature, such as white light or neutral light. Sensor 160 supplies a signal, such as an RGB signal, to light analyzer 162 which may be a conventional device to sense the color temperature of the reflected light. The light analyzer supplies a representation of the sensed color temperature to image generator 112 which compensates the color of the image supplied therefrom to the image projector.

For example, if surface 106 is not a white wall, the color of the image projected on the wall may differ from the color for which the image projector had been calibrated. This color difference is sensed by the combination of sensor 160 and light analyzer 162 to adjust, or compensate, the color of the image generated by image generator 112 and projected by image projector 104. As a result, the color of the projected image that is viewed is corrected, or compensated.

Another configuration for enhancing the image projected by the image projector is illustrated in FIG. 9 in which a light analyzer 168 is used in place of the light analyzer 162 of FIG. 8. Here, light sensor 160 functions as an ambient light sensor. In this configuration, ambient light in the environment of the image projector, namely, ambient light in room 110, is sensed by the light sensor 160 to supply a suitable signal, representing the ambient light intensity, to light analyzer 168. The light analyzer supplies a representation of the sensed ambient light intensity to image generator 112 which, in turn, increases or decreases the brightness of the image projected by image projector 104. For example, if sensor 160 senses an increase in ambient light intensity, the intensity of the image projected by image projector 104 may be increased. Alternatively, if sensor 160 senses a decrease in ambient light intensity, as in a dark room, the intensity of the image projected by the image projector may be reduced. Thus, image projector 104 is controlled to project a light image of intensity matched to the sensed ambient light.

While the present invention has been particularly shown and described with reference to certain preferred embodiments, it will be appreciated that various changes and modifications may be made. For example, although only one image projector has been shown, the present invention may be used with several image projectors to project images that illuminate other walls and also the ceiling of the room. As yet another example, in addition to, or as an alternative to, the image projector, the lighting system in the user's room or home may be controlled in response to the discriminated image information. Still further, if the image information is included in the metadata described above, that metadata may indicate preferred or ideal room lighting color and intensity. It is intended that the appended claims be interpreted to cover the embodiments described herein, the examples mentioned above and equivalents thereto.

What is claimed is:

1. A display system comprising:
an image projector for use with a television display and supplied with image information that differs from but is related to television content displayed by the television display; and
a video decoder for separating image information from content information supplied to said display system, and supplying said image information to said image projector;
wherein said image projector projects an image on a surface separate and apart from a display screen of the television display.

2. The display system of claim 1 wherein television content and image information are received by said display system and separated by said video decoder, said television content being supplied to said television display and said image information being supplied to said projector.

3. The display system of claim 1 wherein said image information is supplied to said display system as metadata, and said video decoder detects said metadata.

4. The display system of claim 3, further including an image generator responsive to said metadata to produce image signals for supplying said image signals to said projector.

5. The display system of claim 4, wherein
the content information supplied to said display system includes said metadata; and
said video decoder includes means for processing said content information to produce video signals and for supplying the television display with said video signals.

6. The display system of claim 4 wherein said metadata represents color or light intensity, and further including a video analyzer for detecting said color or said light intensity and for controlling said projector to project an image whose color or brightness corresponds to the detected color or light intensity.

7. The display system of claim 6 wherein the content information supplied to said display system includes said metadata, and the projected image is controlled in response to said metadata to match the television content displayed by the television display.

8. The display system of claim 4 wherein the content information supplied to said display system includes said metadata, said content information represents a scene to be displayed on the television display and the metadata represents image information to enhance the scene.

9. The display system of claim 1, further comprising:
a sensor for sensing light reflected from said surface to produce reflected light information;
an analyzer supplied with said reflected light information to determine color temperature of the reflected light and for providing color compensation to the image projected by said projector as a function of the determined color temperature.

10. The display system of claim 1, further comprising:
an ambient light sensor for sensing ambient light in the environment of the projected image; and
an analyzer responsive to the sensed ambient light to control the image projector to project a light image of intensity matched to the sensed ambient light.

11. The display system of claim 2 wherein said television content and image information are received in separate channels, and said video decoder separates the television content and image information to supply the television content to said television display and to supply the image information to said projector.

12. The display system of claim 11 wherein said separate channels are left-eye channel and right-eye channel in a 3-D display system.

13. The display system of claim 2 wherein said television content and image information are received via an interactive network, said image information includes selectable image items, and said display system further comprises a user-operated pointer device operable with said projector to superimpose a cursor on said projected image and operable to select an image item over which the cursor is superimposed.

14. The display system of claim 13, further comprising:
a processor for transmitting over the interactive network information representing selected image items.

15. A display system comprising:
an image projector for use with a television display and supplied with image information that differs from, but is related to, content displayed by the television display, the image projector projecting an image separate and apart from the content displayed by said television display;
an input supplied with video content for display by said television display;
means for determining predetermined parameters in said video content; and
means for controlling particular aspects of the image information to cause said image projector to project images in accordance with the predetermined parameters.

16. The display system of claim 15, wherein
said predetermined parameters include light intensity of the video content; and
said means for controlling controls the image projector to project an image whose brightness corresponds to the determined light intensity.

17. The display system of claim 15 wherein said predetermined parameters include sounds, and said means for controlling controls the image projector to project an image whose appearance corresponds to the determined sounds.

18. The display system of claim 15 wherein said predetermined parameters include closed caption information, and said means for controlling controls the image projector to project subtitle images corresponding to said closed caption information.

19. The display system of claim 15 wherein said video content is a sporting event, said predetermined parameters include score information, and said means for controlling controls the image projector to project a scoreboard.

20. The display system of claim 15 wherein said predetermined parameters include a background scene, and said means for controlling controls the image projector to project an expanded view of the background scene.

21. A display system comprising:
a television display for displaying on a display screen video images derived from video content supplied thereto;
an image projector mounted on said television display and supplied with image information that differs from and is received with said video content, said image projector projecting an image derived from said image information onto a surface separate and apart from said display screen; and
a video decoder for decoding image information from said video content, supplying said video content to said television display, and supplying said image information to said image projector.

22. A display system comprising:
a television display for displaying on a display screen video images derived from video content supplied thereto;
an image projector disposed in front of and spaced from said display screen and supplied with image information that differs from and is received with said video content, said image projector projecting an image derived from said image information onto a surface separate and apart from said display screen;
a mask disposed between said image projector and said display screen to inhibit said image from being superimposed on the video content displayed on said display screen; and
a video decoder for decoding image information from said video content, supplying said video content to said television display, and supplying said image information to said image projector.

23. A display method comprising:
receiving image information that differs from but is related to television content displayed by a television display;
separating image information from received content information;
supplying said image information to an image projector; and
projecting an image on a surface separate and apart from a display screen of the television display.

24. The display method of claim 23 further comprising supplying said television content to said television display.

25. The display method of claim 23 wherein said image information is supplied to said display system as metadata, and said step of separating image information comprises detecting said metadata.

26. The display method of claim 25, wherein the detected metadata is used to produce image signals that are supplied to said projector.

27. The display system of claim 26 wherein said metadata represents color or light intensity, and further including detecting said color or said light intensity and controlling said projector to project an image whose color or brightness corresponds to the detected color or light intensity.

28. The display method of claim 27 wherein the projected image is controlled in response to said metadata to match the television content displayed by the television display.

29. The display method of claim 26 wherein the content information represents a scene to be displayed on the television display and the metadata represents image information to enhance the scene.

30. The display method of claim 23, further comprising:
sensing light reflected from said surface to produce reflected light information; and
analyzing said reflected light information to determine color temperature of the reflected light and for providing color compensation to the image projected by said projector as a function of the determined color temperature.

31. The display method of claim 23, further comprising:
sensing ambient light in the environment of the projected image; and
analyzing the sensed ambient light to control the image projector to project a light image of intensity matched to the sensed ambient light.

32. The display method of claim 24 wherein said television content and image information are received in separate channels, and the television content and image information are separated and supplied to said television display and to said projector, respectivley.

33. The display method of claim 32 wherein said separate channels are left-eye channel and right-eye channel in a 3-D display system.

34. The display method of claim 24 wherein said television content and image information are received via an interactive network, said image information includes selectable image items, and further comprising operating a user-operated pointer device to superimpose a cursor on said projected image and selecting an image item over which the cursor is superimposed.

35. The display method of claim 34, further comprising transmitting over the interactive network information representing selected image items.
